(19) United States
(12) Patent Application Publication
(10) Pub. No.: US 2014/0061327 A1
(43) Pub. Date: Mar. 6, 2014

(54) SYSTEM AND METHOD FOR STAGING FUEL TO A COMBUSTOR

(71) Applicant: Michael John Hughes, Greer, SC (US)

(72) Inventor: Michael John Hughes, Greer, SC (US)

(73) Assignee: GENERAL ELECTRIC COMPANY, Schenectady, NY (US)

(21) Appl. No.: 13/601,116

(22) Filed: Aug. 31, 2012

(51) Int. Cl. F02M 61/04

(52) U.S. Cl. 239/5; 239/533.2

(57) ABSTRACT

A system for staging fuel to a combustor includes a fuel manifold with a plurality of valves. At least one fuel circuit provides fluid communication between the fuel manifold and a first set of fuel nozzles. A flow distribution valve is fluidly connected to one of the at least one fuel circuits between the fuel manifold and the first set of fuel nozzles. The flow distribution valve includes an inlet and at least two outlets.

### FIELD OF THE INVENTION

The present invention relates generally to a system and a method for delivering fuel to a combustor.

### BACKGROUND OF THE INVENTION

Gas turbines are widely used in industrial and power generation operations. Gas turbines generally include a compressor, a combustor downstream from the compressor, a turbine downstream from the combustor, a fuel supply and multiple fuel circuits providing a fuel to one or more fuel nozzles at least partially enclosed within the combustor. As the gas turbine and subsequently the combustor cycle through various operating modes, such as start-up, full speed no load, full speed full load and shut down, fuel is allowed to flow through one or more of the multiple fuel circuits to provide fuel to the fuel nozzles within the combustor in a certain sequence to try and balance combustor efficiency, dynamics and emission requirements. Many current combustors typically include four or more fuel nozzles. Because of the cost of accessory systems, it is desirable to group the fuel nozzles into circuits so that the number of fuel circuits, manifolds, control valves, purge circuits, etc. is minimized.

Airflow to each fuel nozzle is a fixed fraction of a total airflow through the combustor. As a result, at low loads, there may not be enough fuel provided to the combustor to sustain a flame if the fuel is equally spread amongst the fuel nozzles. This drives the need for combustor modes, where only a subset of the available fuel circuits may be fueled so that those fuel nozzles can be held at an appropriate fuel/air ratio. Typically, the amount of airflow mixed with fuel for each circuit is a large fraction of the total airflow. This condition can result in a gap between the optimal fuel/air ratio for one mode, and the optimal fuel/air ratio for the next operating mode. As a result, an operating sequence must run modes high in firing temperature, and the next mode runs low in firing temperature. This can result in undesirably high nitrous oxide (NOx) emissions at the high end of a mode, low carbon monoxide (CO) and unburned hydrocarbons (UHCs) emissions at the low end of a mode, and combustion efficiency differences between modes. High emissions at part-load generally prohibit the gas turbine from delivering low emissions at start-up, and combustion efficiency shifts between modes can cause trips or other plant issues as a combustion control system tries to maintain control of the combustion process. Therefore, a fuel staging system that can provide greater combustor mode flexibility without adding an additional fuel circuit would be useful.

### BRIEF DESCRIPTION OF THE INVENTION

Aspects and advantages of the invention are set forth below in the following description, or may be obvious from the description, or may be learned through practice of the invention.

One embodiment of the present invention is a system for staging fuel to a combustor. The system generally includes a fuel manifold including a plurality of valves. At least one fuel circuit provides fluid communication between the fuel manifold and a first set of fuel nozzles. A flow distribution valve is fluidly connected to one of the fuel circuits between the fuel manifold and the first set of fuel nozzles. The flow distribution valve generally includes an inlet and at least two outlets.

Another embodiment of the present invention is a system for staging fuel to a combustor. The system generally includes a fuel manifold with a first valve, a second valve and a third valve. A first fuel circuit provides fluid communication between the first valve and a first set of fuel nozzles. A second fuel circuit provides fluid communication between the second valve and a second set of fuel nozzles. A third fuel circuit provides fluid communication between the third valve and a third set of fuel nozzles. A flow distribution valve is between the third valve and the third set of fuel nozzles. The flow distribution valve generally includes an inlet and at least two outlets in fluid communication with the third set of fuel nozzles.

The present invention also includes a method for supplying fuel to a combustor. The method generally includes flowing fuel through at least one fuel circuit that provides fluid communication between a fuel manifold and a first set of fuel nozzles. Distributing the fuel flow downstream from the fuel manifold and upstream from the combustor, and distributing the fuel flow to a subset of the fuel nozzles in the first set of fuel nozzles.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified schematic of a gas turbine including a fuel delivery system;

FIG. 2 is a schematic of a portion of the gas turbine as shown in FIG. 1, according to one embodiment of the present invention;

FIG. 3 is a schematic of a portion of the gas turbine as shown in FIG. 1 according to another embodiment of the present invention; and

FIG. 4 is an upstream cross-section view of the combustor as shown in FIG. 1.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, “third”, “primary” and “secondary” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a system and a method for staging fuel to a combustor. In general, the system includes one or more fuel circuits and a flow distribution valve with an inlet and at least two outlets. The flow distribution valve provides fluid communication between one of the one or more fuel circuits and a set of fuel nozzles within a combustor. The set of fuel nozzles in fluid communication with the flow distribution valve generally includes at least two subsets of fuel nozzles. Each subset of fuel nozzles is fluidly connected to one of the flow distribution valve outlets. Generally, fuel flows through one or more of the fuel circuits, into the combustor and through the various sets of fuel nozzles as the combustor cycles through various operating modes. The flow distribution valve allows enhanced flexibility to combustor operation by splitting the fuel flowing through one fuel circuit into the subsets of the fuel nozzles, thereby providing fuel to flow into one subset or into both subsets of the fuel nozzles simultaneously. As a result, the combustor may be capable of running a low emissions start-up sequence without having to add the complexity of an entire fuel circuit and the associated components generally related with a compete fuel circuit, thereby reducing costs. Although exemplary embodiments of the present invention will be described generally in the context of a combustor incorporated into a gas turbine for purposes of illustration, one of ordinary skill in the art will readily appreciate that embodiments of the present invention may be applied to any combustor and are not limited to a gas turbine combustor unless specifically recited in the claims.

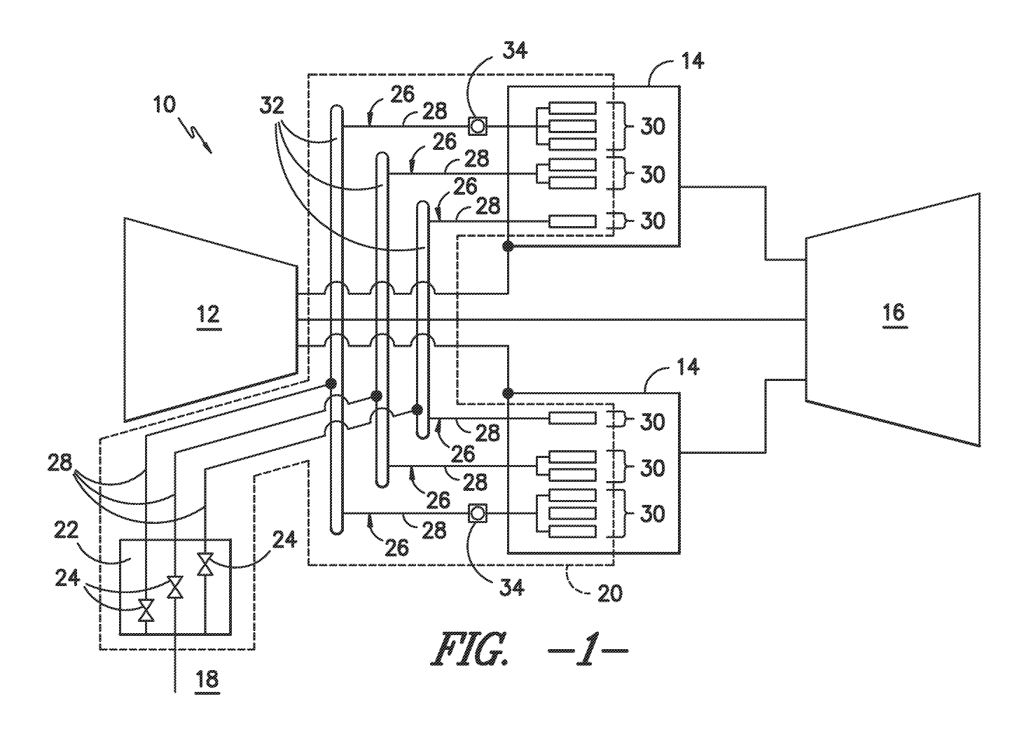

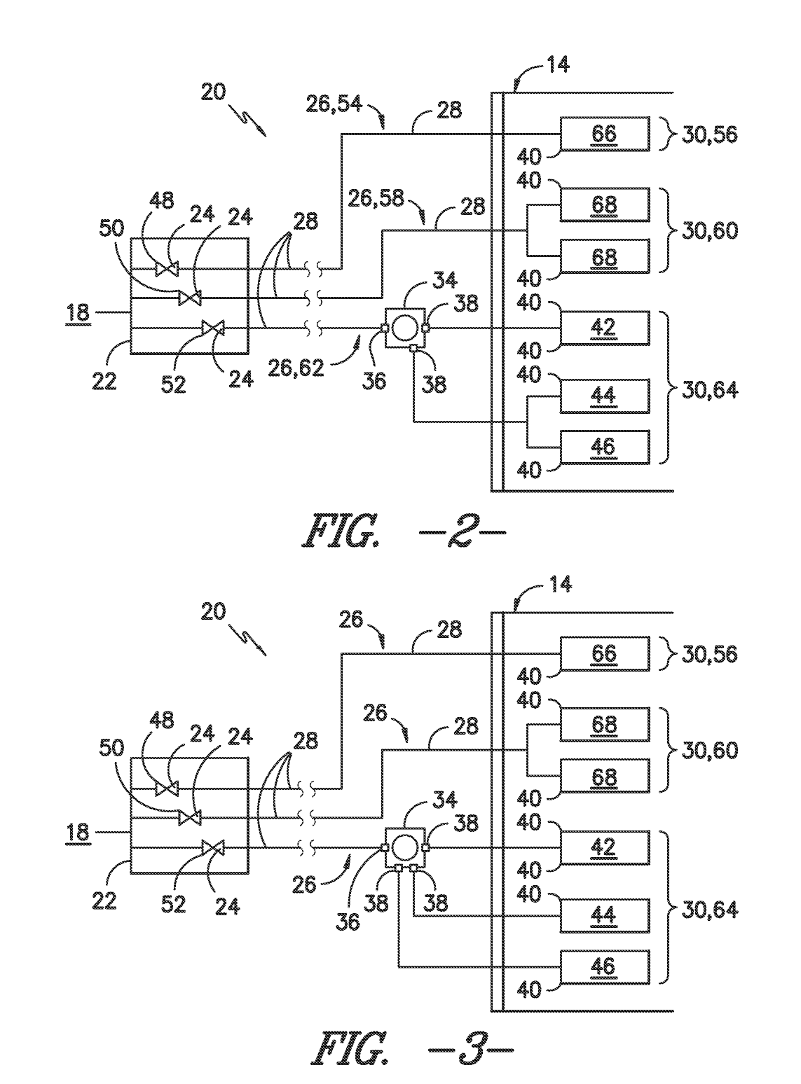

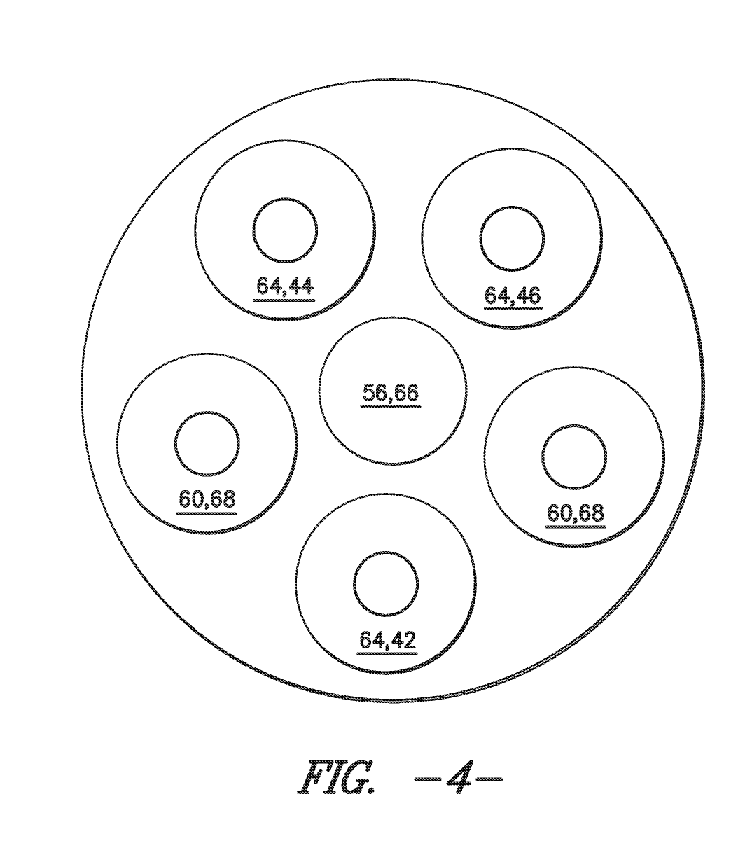

FIG. 1 provides a simplified schematic of a gas turbine 10, FIG. 2 provides a schematic of a portion of the gas turbine as shown in FIG. 1 according to one embodiment of the present invention, and FIG. 3 provides a schematic of a portion the gas turbine as shown in FIG. 1 according to another embodiment of the present invention. As shown in FIG. 1, the gas turbine 10 generally includes a compressor 12, one or more combustors 14 downstream from the compressor 12, a turbine 16 downstream from the one or more combustors 14, and a fuel supply 18 in fluid communication with a system 20 for staging fuel to the one or more combustors 14. As shown in FIGS. 1, 2 and 3, the system 20 generally includes a fuel manifold 22 in fluid communication with the fuel supply 18. The fuel manifold 22 may include a plurality of valves 24 in fluid communication with the fuel manifold and one or more fuel circuits 26. The plurality of valves 24 may include any type of valve designed to control the volumetric flow rate of a fuel flowing through the valve. For example, the plurality of valves 26 may include stop valves, throttle valves, regulator valves, sonic valves or any combination thereof.

The one or more fuel circuits 26 generally includes one or more fluid conduits 28 coupled to the fuel manifold 22 that provide fluid communication between the fuel manifold 22 and at least one set of fuel nozzles 30 within the one or more combustors 14. In particular embodiments, as shown in FIG. 1, each or at least one of the one or more fuel circuits 26 may be fluidly connected to one or more fuel plenums 32 downstream from the fuel manifold 22 and upstream from the one or more combustors 14. The one or more fuel plenums 32 may be at least partially defined by a tube or a series of tubes fluidly connected to the fuel manifold 22 and that at least partially surround the gas turbine 10. In this manner, fuel may flow from the fuel manifold 22, through the at least one of the plurality of valves 24, through at least one of the one or more fluid conduits 28 and into the one or more fuel plenums 32. The fuel may then flow from the one or more fuel plenums 32, through one or more of the fluid conduits 28 and to at least one set of the at least one set of fuel nozzles 30.

As shown in FIGS. 1, 2 and 3, at least one of the one or more fuel circuits 26 may include a flow distribution valve 34 downstream from the fuel manifold 22 and/or the one or more fuel plenums 32 and upstream from the one or more combustors 14. The flow distribution valve 34 generally provides fluid communication between the fuel manifold 22 and/or at least one of the one or more fuel plenums 34 and to one set of the at least one set of fuel nozzles 30. As shown in FIGS. 2 and 3, the flow distribution valve 34 may generally include an inlet 36 fluidly connected to one of the one or more fuel plenums 32 and/or to the fuel manifold 22 through one or more of the one or more fluid conduits 28. The flow distribution valve 34 may also include at least two outlets 38 providing fluid communication from the flow distribution valve 34 to one set of the at least one set of fuel nozzles 30. The flow distribution valve 34 may be any type of flow distribution valve designed to receive fuel through the inlet 36 and distribute the fuel through each of the outlets 38 simultaneously or through any portion of the outlets 38. In particular embodiments, as shown in FIG. 2, the flow distribution valve 34 includes two outlets 38, thus corresponding to a 3-way valve. In this manner, fuel may be directed to from the flow distribution valve 34 through one of the outlets 38, through two of the outlets 38, or the flow distribution valve 34 may be closed to prevent fuel from flowing through either of the outlets 38. As shown in FIG. 3, in further embodiments, the flow distribution valve 34 may include three outlets 38 thus corresponding to a 5-way valve. In this manner, fuel may be directed to from the flow distribution valve 34 through one of the three outlets 38, through any two of the three outlets 38, through three of the three outlets 38, or the flow distribution valve 34 may be closed to prevent fuel from flowing through any of the three outlets 38. In the alternative, the flow distribution valve 34 may be a 4-way valve.

As shown in FIGS. 2 and 3, each of the at least one set of fuel nozzles 28 may include one or more fuel nozzles 40. For example, each of the at least one set of fuel nozzles 30 may include one, two or three of the fuel nozzles 40. In particular embodiments, one set of the at least one set of fuel nozzles 30 may be divided into one or more subsets of fuel nozzles 40. For example, as shown in FIG. 2, one of the at least one set of fuel nozzles 30 containing three fuel nozzles 40 may be divided into two subsets. One subset may include a primary fuel nozzle 42 and a second subset may include two secondary fuel nozzles 44 and 46. In the alternative, one set of the at least one set of fuel nozzles 30 including three fuel nozzles 40 may be divided into three subsets including one subset having one of the primary fuel nozzle 42, a second subset having one of the secondary fuel nozzles 44, and a third subset having one of the secondary fuel nozzles 46. Each subset of the fuel nozzles is fluidly connected to at least one of the one or more outlets 38 of the flow distribution valve 34. In this manner, the fuel may be distributed to the primary fuel nozzle 42 and/or the secondary fuel nozzles 44 and/or 46 as desired to enhance efficiency of the combustor.

In one embodiment, as shown in FIG. 2, the plurality of valves 24 includes a first valve 48, a second valve 50 and a third valve 52. The at least one fuel circuit 26 includes a first fuel circuit 54 that provides fluid communication between the first valve 48 and a first set of fuel nozzles 56 of the at least one set of fuel nozzles 30. The at least one fuel circuit 26 also includes a second fuel circuit 58 that provides fluid communication between the second valve 50 and a second set of fuel nozzles 60 of the at least one set of fuel nozzles 30, and a third fuel circuit 62 of the at least one fuel circuit 26 provides fluid communication between the third valve 52 and a third set of fuel nozzles 64 of the at least one set of fuel nozzles 30. The flow distribution valve 34 provides fluid communication between the third valve 52 and the third set of fuel nozzles 64.

As shown in FIGS. 2, 3 and 4, the first set 56 of fuel nozzles includes a center fuel nozzle 66 receiving fuel from the first fuel circuit 54. The second set of fuel nozzles 60 includes two outer fuel nozzles 68, receiving fuel from the second fuel circuit 58. The third set of fuel nozzles 64 is divided into two subsets. The first subset of the third set of fuel nozzles 64 includes one of the primary fuel nozzle 42 fluidly connected to one of the flow distribution valve 34 outlets 38. The second subset of the third set of fuel nozzles 64 includes two secondary fuel nozzles 44 and 46, fluidly connected to one of the two flow distribution valve 34 outlets 38. In this configuration, the flow distribution valve expands the flexibility of the combustor by allowing enhanced control over the various fuel nozzles 42, 44 and 46 as the combustor cycles through various operating conditions. For example, as the first fuel circuit 56 provides fuel to the combustor through the center nozzle 66 and/or the second fuel circuit 60 provides fuel to the combustor 14 through the outer nozzles 68, the flow distribution valve 34 may allow fuel to flow through only the primary fuel nozzle 42, through only the secondary fuel nozzles 44 and 46, through both the primary fuel nozzle 42 and the secondary fuel nozzles 44 and 46, or the flow distribution valve may be closed to prevent fuel from flowing through the primary fuel nozzle 42 or the secondary fuel nozzles 44 and 46.

In the alternative, as shown in FIG. 3, the flow distribution valve 34 may include three of the outlets 38 in fluid communication with the third set of fuel nozzles 64. In this configuration, the third set of fuel nozzles 64 may be divided into three subsets. The first subset includes the primary nozzle 42 in fluid communication with one of the outlets 38, the second subset includes one of the secondary fuel nozzles 44 in fluid communication with another one of the outlets 38 and the third subset includes another one of the secondary fuel nozzles 46 in fluid communication with another one of the outlets 38. In this configuration, for example, as the first fuel circuit 56 and/or the second fuel circuit 60 provide fuel to the combustor 14, the flow distribution valve may allow fuel to flow through only the primary fuel nozzle 42, through only one of the secondary fuel nozzles 44 or 46, through both of the secondary fuel nozzles 44 and 46, through both the primary fuel nozzle 42 and the secondary fuel nozzles 44 and 46, or the flow distribution valve may be closed to prevent fuel from flowing through the primary fuel nozzle 42 or the secondary fuel nozzles 44 and 46. This configuration may also provide enhanced flexibility when staging fuel to the combustor.

The systems described and illustrated in FIGS. 1-4 provide a method for staging a fuel to a combustor. Specifically, the method includes flowing fuel through at least one of the at least one fuel circuits 26, distributing the fuel flow downstream from the fuel manifold 22 and upstream from the one or more combustors 14, and distributing the fuel flow to a subset of the fuel nozzles in a first set of the at least one set of fuel nozzles 30. The method may further include distributing the fuel flow to the primary fuel nozzle 42 of the subset of fuel nozzles. The method may also include distributing the fuel flow to at least two of the secondary fuel nozzles 44 and 46. The method may also include distributing the fuel flow to the primary fuel nozzle 42 and at least two of the secondary fuel nozzles 44 and 46.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal language of the claims.

What is claimed is:

1. A system for staging fuel to a combustor, the system comprising:
a. a fuel manifold comprising a plurality of valves;
b. a fuel circuit that provides fluid communication between said fuel manifold and a first set of fuel nozzles; and
c. a flow distribution valve in fluid communication with the fuel circuit, the flow distribution valve between said fuel manifold and said first set of fuel nozzles, wherein said flow distribution valve includes an inlet and at least two outlets.

2. The system as in claim 1, wherein said first set of fuel nozzles comprises a primary fuel nozzle in fluid communication with one of the at least two outlets of the flow distribution valve.

3. The system as in claim 1, wherein said first set of fuel nozzles comprises at least two secondary fuel nozzles in fluid communication with one of the at least two outlets of the flow distribution valve.

4. The system as in claim 1, wherein said flow distribution valve comprises a third outlet.

5. The system as in claim 4, wherein said first set of fuel nozzles comprises at least one secondary fuel nozzle in fluid communication with said third outlet.

6. The system as in claim 1, wherein said flow distribution valve is a 3-way valve.

7. The system as in claim 1, wherein said flow distribution valve is a 4-way valve.

8. The system as in claim 1, wherein said flow distribution valve is a 5-way valve.

9. The system as in claim 1, further comprising a fuel plenum in fluid communication with the fuel manifold and the fuel circuit.

10. A system for staging fuel to a gas turbine, the system comprising:
a. a compressor;
b. a combustor downstream from the compressor;
c. a fuel manifold comprising a first valve, a second valve and a third valve;
d. a first fuel circuit that provides fluid communication between said first valve and a first set of fuel nozzles, the first set of fuel nozzles disposed within the combustor;
e. a second fuel circuit that provides fluid communication between said second valve and a second set of fuel nozzles, the second set of fuel nozzles disposed within the combustor;
f. a third fuel circuit that provides fluid communication between said third valve and a third set of fuel nozzles, the third set of fuel nozzles disposed within the combustor; and
g. a flow distribution valve between said third valve and the third set of fuel nozzles, wherein said flow distribution valve includes an inlet and at least two outlets in fluid communication with the third set of fuel nozzles.

11. The system as in claim 10, wherein the third set of fuel nozzles includes a primary fuel nozzle in fluid communication with one of said at least two outlets of the flow distribution valve.

12. The system as in claim 10, wherein the third set of fuel nozzles includes at least one secondary fuel nozzle in fluid communication with one of said at least two outlets of the flow distribution valve.

13. The system as in claim 10, wherein said flow distribution valve comprises a third outlet.

14. The system as in claim 13, wherein the first set of fuel nozzles comprises at least one secondary fuel nozzle in fluid communication with said third outlet.

15. The system as in claim 10, wherein said flow distribution valve is a 3-way valve.

16. The system as in claim 10, wherein said flow distribution valve is a 5-way valve.

17. A method for staging fuel to a combustor, the method comprising:
a. flowing fuel through at least one fuel circuit that provides fluid communication between a fuel manifold and a first set of fuel nozzles;
b. distributing the fuel flow downstream from said fuel manifold and upstream from the combustor; and
c. distributing the fuel flow to a subset of the fuel nozzles in the first set of fuel nozzles.

18. The method as in claim 17, further comprising distributing the fuel flow to a primary fuel nozzle of the subset of the fuel nozzles.

19. The method as in claim 17, further comprising distributing the fuel flow to at least two secondary fuel nozzles of the subset of the fuel nozzles.

20. The method as in claim 17, further comprising distributing the fuel flow to a primary fuel nozzle and at least two secondary fuel nozzles of the subset of the fuel nozzles.
